(19) United States
(12) Patent Application Publication
(10) Pub. No.: US 2026/0178049 A1
(43) Pub. Date: Jun. 25, 2026

(54) SYSTEM FOR AUTOMATED SPEED CONTROL IN A ROADBUILDING MACHINE

(71) Applicant: Roadtec, Inc., Chattanooga, TN (US)

(72) Inventors: Brad Rowan, Chattanooga, TN (US); Robert Bauer, Saint Croix Falls, WI (US); Cru Palmer, Chattanooga, TN (US); Roberto Da Silva, Chattanooga, TN (US)

(73) Assignee: Roadtec, Inc., Chattanooga, TN (US)

(21) Appl. No.: 19/430,517

(22) Filed: Dec. 23, 2025

Related U.S. Application Data
(60) Provisional application No. 63/737,884, filed on Dec. 23, 2024.

(51) Int. Cl. G05D 1/65; E01C 19/48; G05D 107/90

(52) U.S. Cl. CPC G05D 1/65; E01C 19/48; E01C 2301/00; G05D 2107/90

(57) ABSTRACT

A control system for road building machines, particularly pavers, that automatically transitions the machine between operational states using closed-loop feedback control to achieve consistent paving joints. The system comprises a speed input mechanism for setting target speeds, a launch control input for initiating transitions, a controller executing closed-loop feedback control algorithms, and sensors monitoring machine speed, position, velocity, acceleration, and electrical current. The controller automatically generates controlled acceleration profiles using real-time sensor feedback to transition the machine from a first operational state to a second operational state, where each state may be either stationary or moving at a specified speed. This enables consistent transitions when starting from rest, accelerating to higher speeds, decelerating to lower speeds, or stopping, thereby eliminating variability in joint formation caused by manual operation. Optional directional control provides emergency stop functionality. The system may be retrofitted to existing equipment or integrated into new machines, and can be implemented through software updates to existing control systems.

### CROSS REFERENCE TO RELATED APPLICATION

This application relates back to and claims the benefit of priority from U.S. Provisional Application No. 63/737,884, filed Dec. 23, 2024, and titled “Smart Joint,” which is incorporated herein by reference in its entirety.

### FIELD

This invention relates to road building machines, particularly pavers or paving machines, and more specifically to methods and systems for automated control of machine speed transitions using closed-loop feedback control. The system enables controlled transitions between operational states, including starting from rest, accelerating to higher speeds, decelerating to lower speeds, and stopping, thereby producing high-quality joints and consistent paving operations.

### BACKGROUND

Paving operations frequently require stopping and restarting the paving machine for various operational reasons including waiting for material delivery, shift changes, traffic control, and equipment adjustments. Each restart creates a “joint” where the newly placed material meets the previously placed material. The quality of these joints is critical to pavement longevity and performance.

A poorly formed paving joint creates a structural weakness in the pavement. When the paving machine restarts inconsistently, including either too abruptly or too gradually, the newly placed material does not properly integrate with the existing material. This creates a visible and physical discontinuity in the pavement surface. Such joints are particularly vulnerable to water infiltration, which can lead to base erosion, freeze-thaw damage, and accelerated deterioration. Over time, improperly formed joints may develop cracks, depressions, and other surface deformities that compromise pavement integrity and necessitate costly repairs.

Among other things, the quality of paving joints depends heavily on the consistency of the paving machine “launch” (e.g., transitioning from a stationary state to a moving state, including an operational paving speed of travel, transitioning from a moving state to a stationary state, or transitioning from one moving state to another different moving state). Often, conventional paving machines and paving processes rely entirely on operator skill to manage the launch process. However, even highly skilled operators cannot reliably achieve perfectly consistent launches due to variations in their reaction time, coordination, and judgment of environmental conditions. Factors such as ground conditions, machine load, ambient temperature, and material properties affect the optimal launch profile, but an operator cannot simultaneously account for all these variables while manually controlling the paving machine's acceleration. One reason is that conventional road building machines typically provide manual controls for speed and direction. The operator adjusts these controls based on experience and judgment. However, even skilled operators cannot achieve the consistency needed and simultaneously account for all relevant factors.

In addition to launch from a stationary state, paving operations also require frequent speed adjustments during operation. Operators must increase speed when conditions allow for faster paving, decrease speed when precision is required, and execute controlled stops for material loading or traffic control. Each speed transition affects material placement quality. Manual speed control introduces the same variability problems as manual launch. Inconsistent acceleration and deceleration create uneven material density, surface irregularities, and compromised joint quality. Conventional systems provide no automated assistance for these mid-operation transitions, leaving operators to manually manage acceleration and deceleration while simultaneously controlling direction, monitoring material flow, and observing surface quality.

What is needed is a system and method that automates speed transitions to ensure smooth, consistent, and repeatable transitions between operational states, thereby producing high-quality paving joints regardless of environmental conditions or operator variability.

### SUMMARY OF THE INVENTION

The present invention provides a system and method for automated control of road building machine speed transitions. The method enables reliable and repeatable performance across all operational transitions by automating speed control using closed-loop feedback control. In preferred embodiments, the method comprises receiving, at a controller, an operator-selected target speed via a speed input mechanism. A launch initiation command is received via a launch control input. The controller automatically generates a controlled acceleration profile using closed-loop feedback control, wherein the controlled acceleration profile utilizes real-time sensor data comprising at least one of machine speed, position, velocity, acceleration, and electrical current supplied to propulsion components. The controller continuously and automatically calculates control outputs to adjust acceleration in real-time based on the sensor data and automatically transitions the machine from a first operational state to a second operational state at the target speed without operator input during the transition. The controller maintains the target speed during operation using continued closed-loop feedback control. The first operational state may be a stationary state or a movement state at a first speed, and the second operational state may be a stationary state or a movement state at a second speed different from the first speed.

The invention further implements a control hierarchy wherein the direction control device functions as a master control. When transitioned to the neutral state during machine motion, the direction control device immediately arrests all motion regardless of other control inputs. The launch control input is subordinate to the direction control device such that the launch control input cannot initiate machine movement when the direction control device is in the neutral state.

The invention further provides a road building machine system comprising a speed input mechanism configured to receive an operator-selected target speed and a direction control device configured to receive operator input to transition between a neutral state and a forward state. The direction control device provides an immediate stop when transitioned to the neutral state during machine motion and functions as a master control that prevents any other control input from initiating machine movement when in the neutral state. A launch control input is configured to receive a launch initiation command when the direction control device is in the forward state. One or more sensors are configured to collect real-time data comprising at least one of machine speed, position, velocity, acceleration, and electrical current supplied to propulsion components.

The system provides consistent automated control whether transitioning from stationary to moving, from one movement speed to another movement speed, or from moving to stationary, thereby eliminating operator variability across all speed changes during paving operations.

A controller is configured to receive the target speed from the speed input mechanism and receive the real-time data from the one or more sensors. The controller automatically generates a controlled acceleration profile using closed-loop feedback control that continuously calculates and adjusts control outputs based on the real-time data. The controller automatically transitions the machine from a first operational state to a second operational state at the target speed using the controlled acceleration profile without operator input during the transition and maintains the target speed during operation using continued closed-loop feedback control.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity.

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted.

The phrase “providing,” including as used in the claims, may mean directly or indirectly. Therefore, as an example, providing an operator-selected target speed to a road building machine system includes providing the target speed both directly and indirectly to a road building machine.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 is a data flow diagram illustrating the route through which the system's signals travel according to an embodiment of the present invention;

FIG. 2 illustrates the initial portion of a flowchart showing the system processes for initiating and executing a controlled operational state transition in accordance with one embodiment of the invention;

FIG. 3 provides a continuation of the flowchart shown in FIG. 2, detailing the steps involved in computing and implementing the controlled acceleration profile as part of the launch process;

FIG. 4 is a continuation of the flowchart in FIG. 3, illustrating the steps that result in controlled negative acceleration and stopping;

FIG. 5 is a continuation of the flowchart shown in FIG. 4, illustrating the steps that complete the stopping process and fully arrest machine motion;

FIG. 6 is a state diagram illustrating control states and state transitions for a controlled launch system according to an embodiment of the present invention;

FIG. 7 is a perspective view of a road building machine according to an embodiment of the present invention;

FIG. 8 is an exploded view of a track assembly of the road building machine of FIG. 7 depicting a track drive, and tracks;

FIG. 9 is a perspective view of the track drive of the track assembly of FIG. 8 showing a connected position pulse unit (PPU);

FIG. 10 is a perspective view of the road building machine of FIG. 7 showing more closely the operator seats;

FIG. 11 illustrates two perspective views of an operator seat assembly, showing the left-hand console and the right-hand console according to an embodiment of the present invention;

FIG. 12 is a perspective view of the left-hand console of FIG. 11 illustrating a keypad, screed float switch, and a speed input mechanism;

FIG. 13 is a top plan view of the keypad of FIG. 12 depicting the launch control input;

FIG. 14 is a top perspective view of the right-hand console of FIG. 11 illustrating a keypad and a directional control device;

FIG. 15 is a bottom perspective view of the right-hand console of FIG. 14 illustrating the underside of the directional control device and a launch input control; and

FIG. 16 is a top plan view of the keypad of FIG. 14 depicting the parking brake switch.

### DETAILED DESCRIPTION

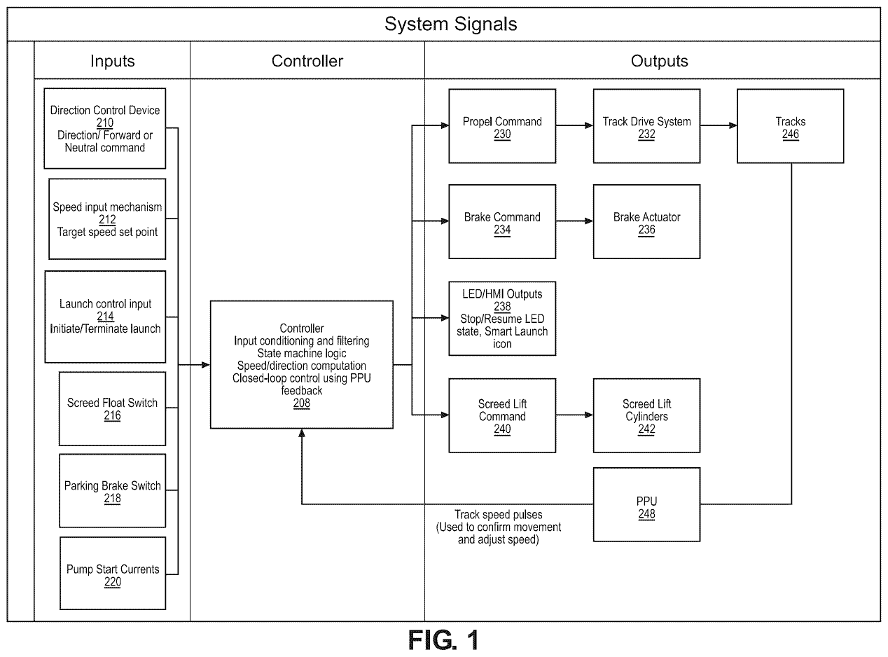

Referring to the drawings, and with particular reference to FIG. 1, there is shown a data flow diagram illustrating how the system's inputs; the direction control device 210, the speed input mechanism 212, the launch control input 214, the screed float switch 216, the parking brake switch 218, and the pump start currents 220, when engaged all transmit signals to the controller 208. The controller then filters those inputs according to the output; the propel command 230, the brake command 234, the LED/HMI outputs 238, and the screed lift command 240. The propel commands 230 further route signals to the track drive system 232 which routes signals to the tracks 246 of the road building machine 100, which is depicted as a road paving machine. The position pulse units (PPUs) 248 detect the rotational position and speed of the tracks 246, converting these measurements into movement and speed signals. These signals are then transmitted to the controller 208, which uses them as feedback inputs in the closed-loop control to continuously adjust propulsion and maintain the target speed. Further shown is that the brake actuator 236 receives signals from the brake command 234 and the screed lift cylinders 242 receive signals from the screed lift command 240.

The direction control device 210 functions as the master control of the system. When the direction control device 210 is transitioned to the neutral state while the machine 100 is in motion, the controller 208 immediately arrests all motion regardless of any other control inputs. This provides emergency stop functionality that overrides the controlled acceleration profile and any other operational commands. The controller 208 implements a control hierarchy wherein the launch control input 214 is subordinate to the direction control device 210. When the direction control device 210 is in the neutral state, the launch control input 214 cannot initiate or maintain machine movement regardless of operator input. The controller 208 checks the state of the direction control device 210 before responding to commands from the launch control input 214, and only when the direction control device 210 is in the forward state does the controller 208 permit the launch control input 214 to initiate or control machine movement.

The direction control device 210 also provides steering control, allowing the operator to turn the machine left or right while maintaining the controlled speed profile.

The controller 208 continuously monitors electrical currents supplied to the propulsion components, including the pump start currents 220 and currents to the track drive system 232. By monitoring these currents in real-time, the controller 208 can detect variations in load, ground conditions, and other factors that affect acceleration, allowing the controller 208 to adjust control outputs to maintain consistent acceleration despite varying conditions.

While the illustrated embodiment shows the system transitioning from a stationary state to a moving state (i.e., a launch operation), the system is equally applicable to other transitions. The controller 208 can generate controlled acceleration profiles for transitions from a first movement speed to a second movement speed (e.g., increasing from 20 feet per minute to 40 feet per minute), as well as controlled negative acceleration profiles for transitions from a moving state to a stationary state or from a higher speed to a lower speed. In each case, the closed-loop feedback control continuously monitors real-time sensor data and adjusts control outputs to achieve smooth, consistent transitions regardless of the starting and ending operational states.

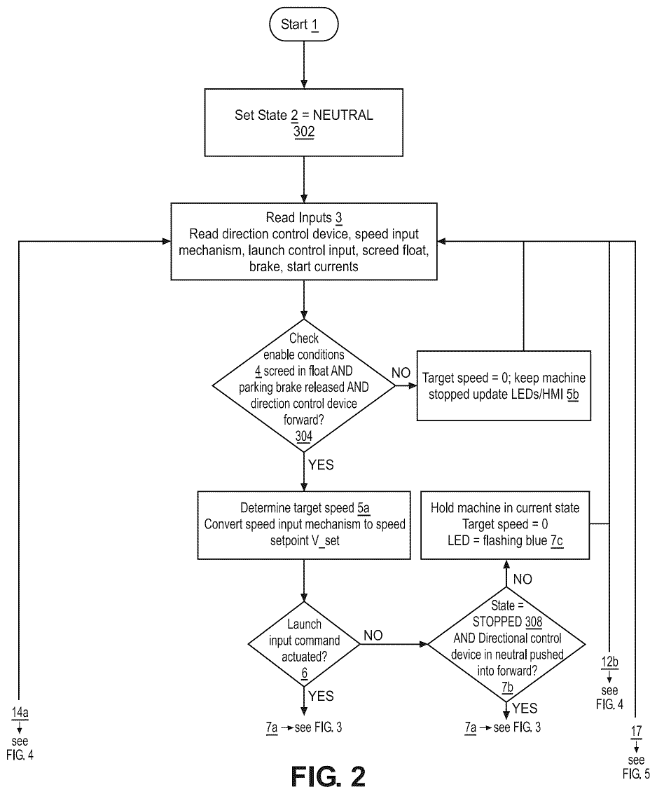

FIGS. 2-5 illustrate consecutive portions of a single flowchart showing the system processes for initiating and executing a controlled operational state transition, including controlled acceleration from one state to another. Referring specifically to FIG. 2, the process begins at STEP 1 where the machine 100 is powered on, followed by STEP 2, where the machine 100 is in a neutral state 302. At STEP 3, the controller 208 reads inputs from the direction control device 210, speed input mechanism 212, launch control input 214, screed float switch 216, the parking brake switch 218, and the pump start currents 220. STEP 4 validates the enable conditions, specifically verifying that the screed is in float AND the parking brake is released AND the direction control device 210 is in the forward state 304.

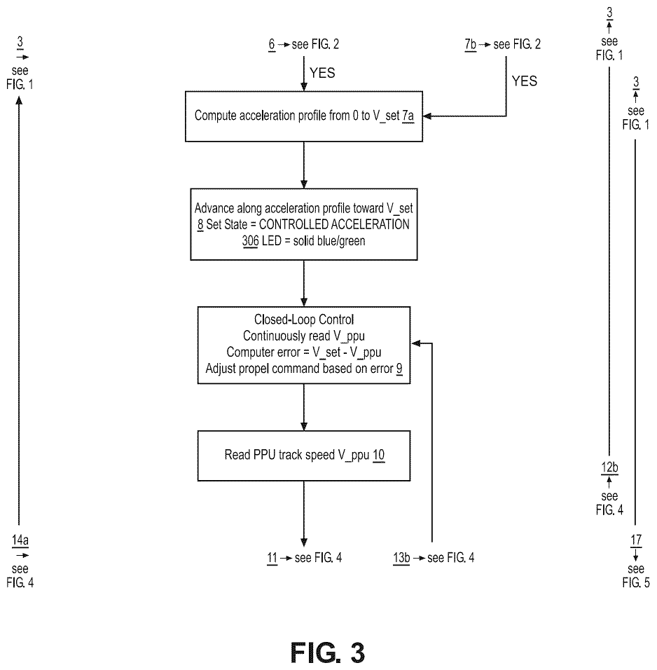

If the enable conditions are met, the controller proceeds to STEP 5a, where the system determines the target speed by converting the input from speed input mechanism 212 into a speed setpoint V_set. If enable conditions are not met, then at STEP 5b the target speed equals 0 to keep the machine 100 stopped, and the LEDs and the human-machine interface (HMI) are updated to provide operator feedback. Following STEP 5a is STEP 6, where the controller determines whether the launch input command has been actuated. If yes, the process advances to STEP 7a as shown in FIG. 3. If not, then at STEP 7b the machine 100 remains in the stopped state 308. If the direction control device is pushed to forward then the process also proceeds to STEP 7a as shown in FIG. 3.

The controlled acceleration profile computed at STEP 7a applies whether the machine 100 is transitioning from stationary to V_set, from a first speed to V_set, or decelerating from a higher speed to V_set. The controller 208 determines the current operational state and generates an appropriate acceleration (positive or negative) profile to reach the target speed.

If the direction control device 210 is in neutral then the machine 100 remains at its current state with the target speed set to zero and the LEDs 238 flashing blue at STEP 7c. The sequence then returns to STEP 3 to await further operator commands.

With reference to FIG. 3, at STEP 7a, the controller 208 computes a controlled acceleration profile from 0 to V_set (the operator-selected target speed). At STEP 8, the controller 208 advances along this profile toward V_set using the real-time sensor data which includes at least one of the following: machine speed, position, velocity, acceleration, and electrical current supplied to the PPUs 248 from the track, within a closed loop feedback control. At STEP 9 the system enters the controlled acceleration state 306 and updates the LED indicator 238 to solid blue/green, providing visual confirmation that controlled launch is active. STEP 10 continues the closed-loop feedback control to maintain the target speed during operation.

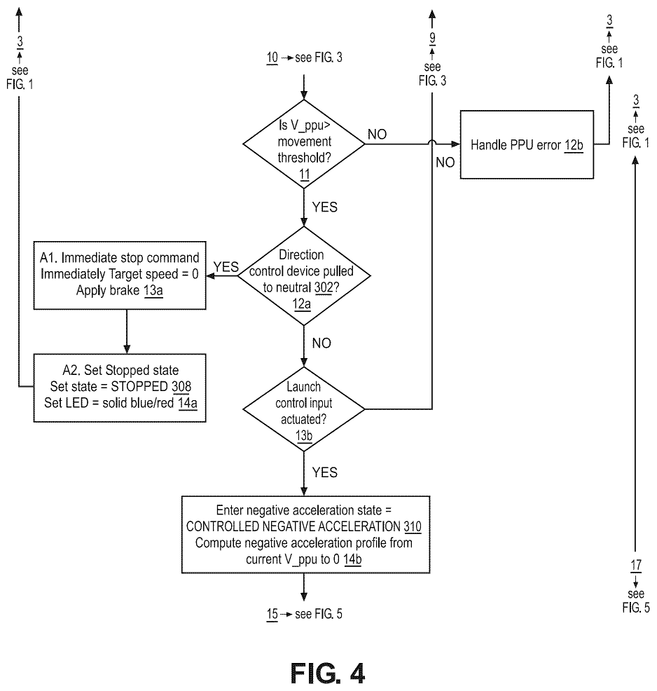

Referring now to FIG. 4, which illustrates controlled deceleration and stopping processes, at STEP 11, the controller 208 evaluates whether the velocity, as measured by position pulse units (Vₚₚᵤ), exceeds the predefined movement threshold. If not, the controller proceeds to STEP 12b to address any error related to the Vₚₚᵤ. The sequence then returns to STEP 3 in FIG. 2 to await further operator commands. If yes, the process advances to STEP 12a, where the controller 208 checks whether the direction control device 210 has been moved to neutral. If yes, then at STEP 13a the controller issues an immediate stop command, sets the target speed to zero, and applies the brakes. At STEP 14a, the machine 100 transitions into the stopped state 308. The sequence then returns to STEP 3 in FIG. 2 to await further operator commands

If, at STEP 12a, the direction control device 210 has not been moved to neutral, the controller 208 then assesses whether the launch control input 214 has been actuated at STEP 13b. If not, the controller 208 returns to STEP 9 and continues that sequence. If the launch control input has been actuated, the controller proceeds to STEP 14b, where the system enters the controlled negative acceleration state 310, and the machine 100 begins to decelerate.

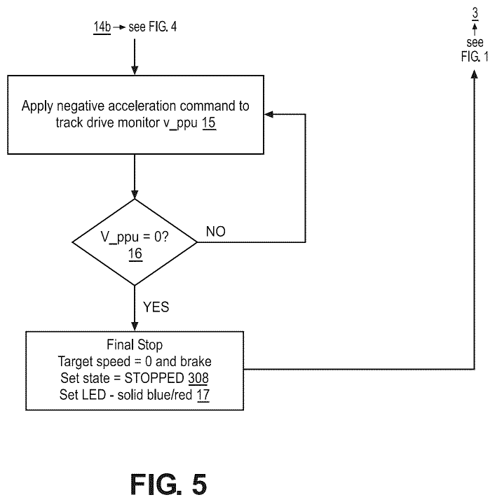

With reference to FIG. 5, at STEP 15 the controller 208 issues a negative acceleration command to the track drive 232 and monitors Vₚₚᵤ. At STEP 16, the controller checks whether Vₚₚᵤ equals zero, indicating the machine 100 has stopped. If not, the process returns to STEP 15 for continued monitoring. If yes, the controlled stop is complete, and the process advances to STEP 17, where the machine 100 is in the stopped state 308 with a target speed of zero. The sequence then returns to STEP 3 in FIG. 2 to await further operator commands.

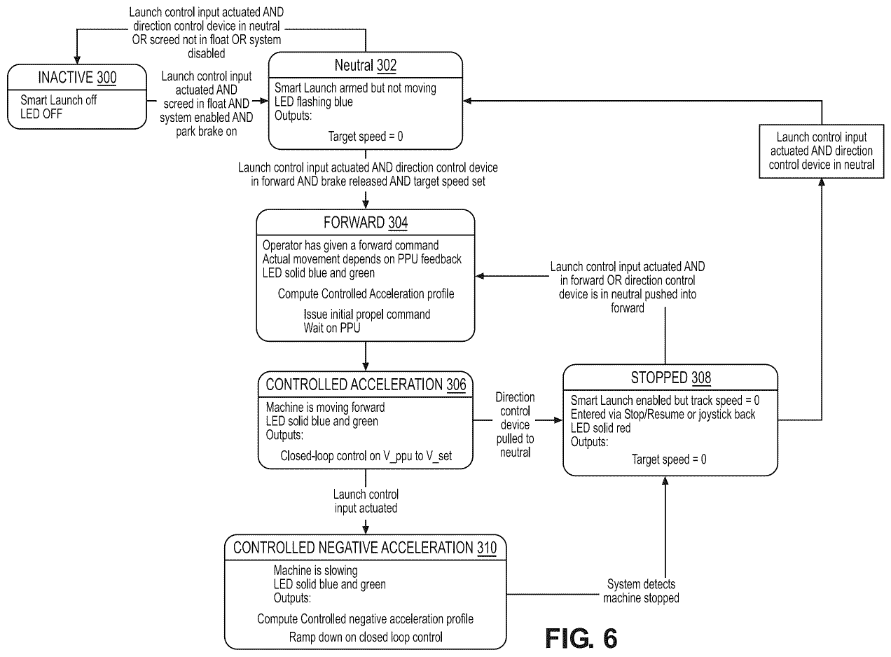

Turning now to FIG. 6, there is shown a state diagram depicting the control hierarchy and state transitions according to an embodiment of the present invention. The process begins in the inactive state 300 where the launch system is off, and the LEDs (238) are off. The system remains in this state if the launch control input (214) is not actuated, the direction control device 210 is in neutral, or the screed not in float or parking brake engaged. When the launch control input 214 is actuated (turning the launch system on) and the direction control device is in neutral, the system transitions to the neutral state 302. In this state, the launch system is armed but the machine 100 is not moving, the LED 238 flashes blue, and the target speed is set to zero. If the direction control device 210 is then moved to forward, and the brake is released, the system enters the forward state 304. Here, actual movement now depends on PPU 248 feedback. The LED 238 turns solid blue and green. Outputs include computing a controlled acceleration profile, issuing the initial propel command 230, and waiting on PPU 248 confirmation.

Once movement begins, the system transitions to the controlled acceleration state 306. In this state, the machine 100 is moving forward under closed-loop control, following the acceleration profile toward the target speed (i.e., V_set). The LED remains solid blue and green. If the launch control input is actuated while the machine 100 is moving, the system can enter controlled negative acceleration 310. Here, the machine 100 slows down under a controlled deceleration profile, ramping down speed using closed-loop control. The LED remains solid blue and green. Once the machine reaches a target speed of zero, the system enters the stopped state 308. In this state, the launch system is enabled but the target speed is zero. The LED turns solid red, and the machine 100 remains stationary until further operator input. From this state, the operator can set a new target speed and initiate another transition to a moving state, or the system can transition to other operational states as previously described.

The control hierarchy establishes the direction control device 210 as the master control, with the launch control input 214 subordinate to it. When the direction control device 210 is in the neutral state, the launch control input 214 cannot initiate or maintain machine movement regardless of operator input. The controller 208 implements this hierarchy by checking the state of the direction control device 210 before responding to commands from the launch control input 214. Only when the direction control device 210 is in the forward state does the controller 208 permit the launch control input 214 to initiate or control machine movement.

The controller 208 may be implemented using one or more processors executing instructions stored on a non-transitory computer-readable medium. The instructions, when executed, cause the controller 208 to perform the operations described herein, including receiving input signals, generating controlled acceleration profiles, calculating control outputs using closed-loop feedback, and transmitting control signals to the propulsion components and other systems. The computer-readable medium may include any type of memory device, including but not limited to flash memory, ROM, RAM, EEPROM, or other storage media capable of storing executable instructions.

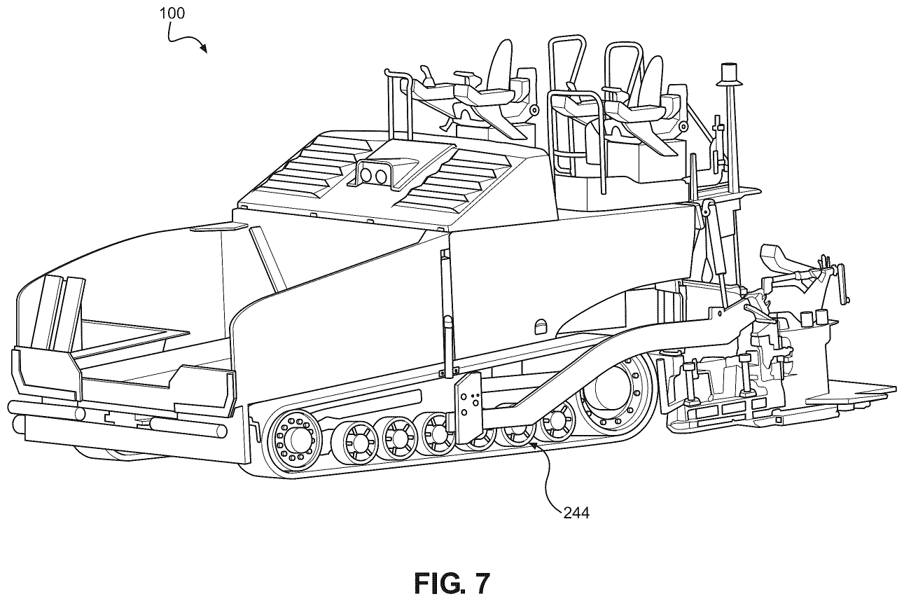

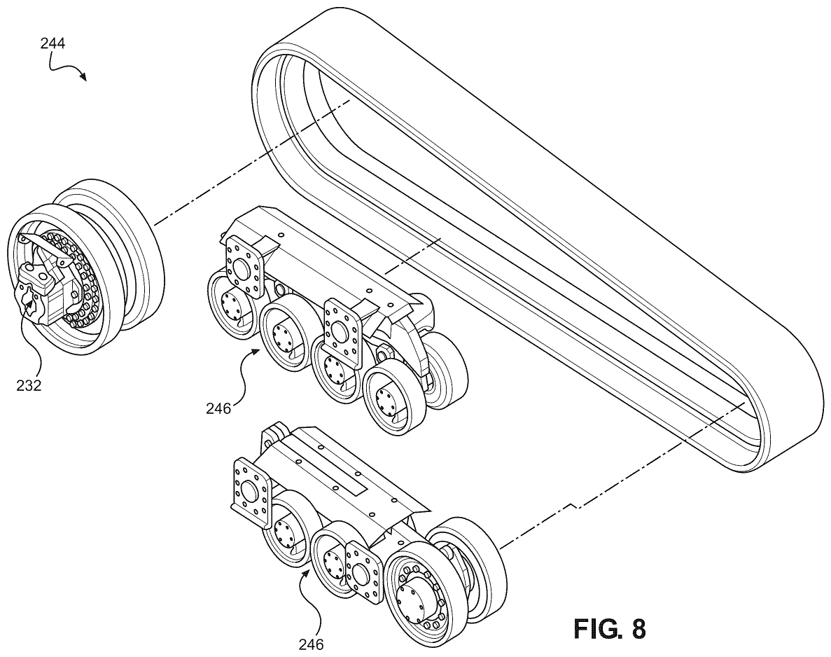

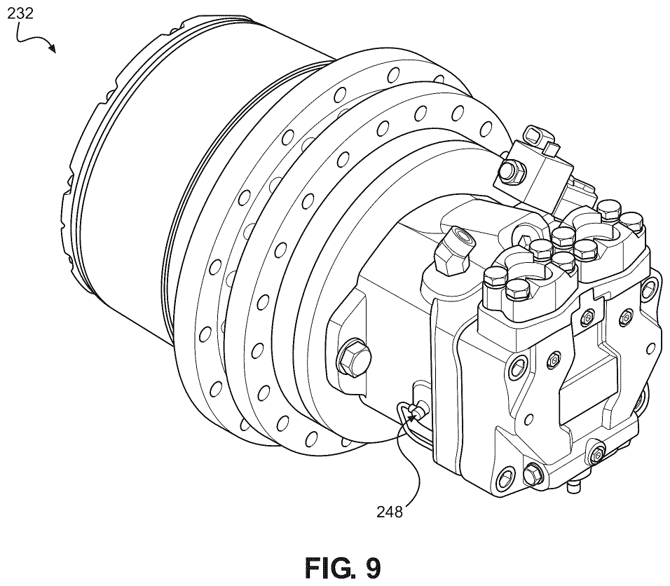

Turning now to FIGS. 7-16, an embodiment of the present invention is illustrated. Referring to FIG. 7, a road building machine 100 is shown along with a track assembly 244. FIG. 8 depicts track drive 232 and tracks 246 that make up the track assembly 244. FIG. 9 further illustrates the PPU 248 connected to the track drive 232 enabling data collection from tracks 246.

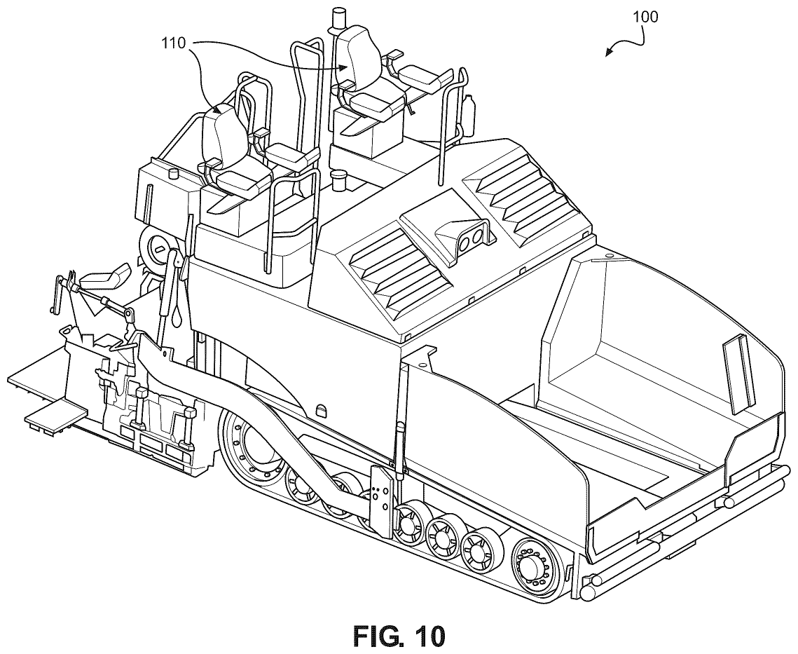

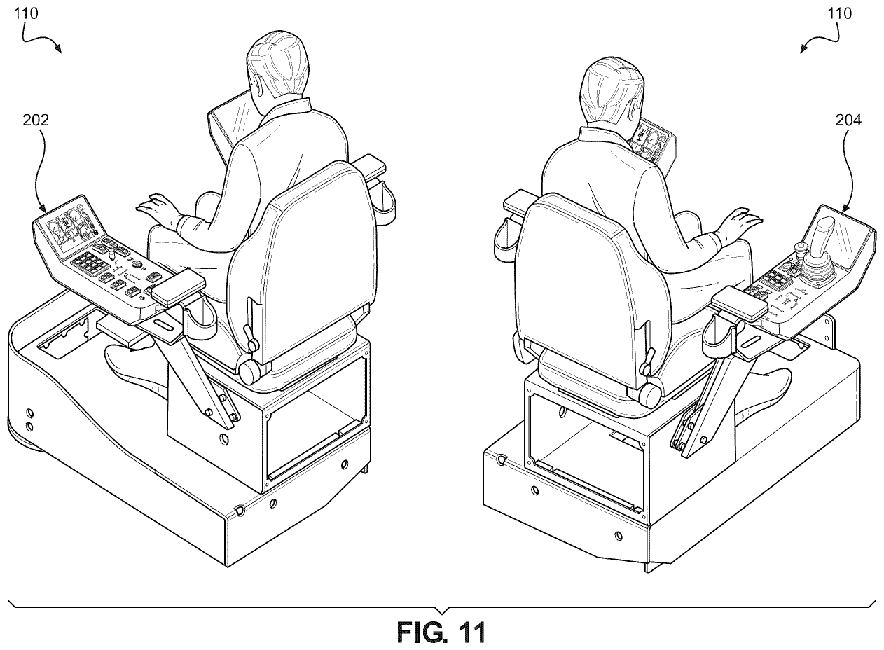

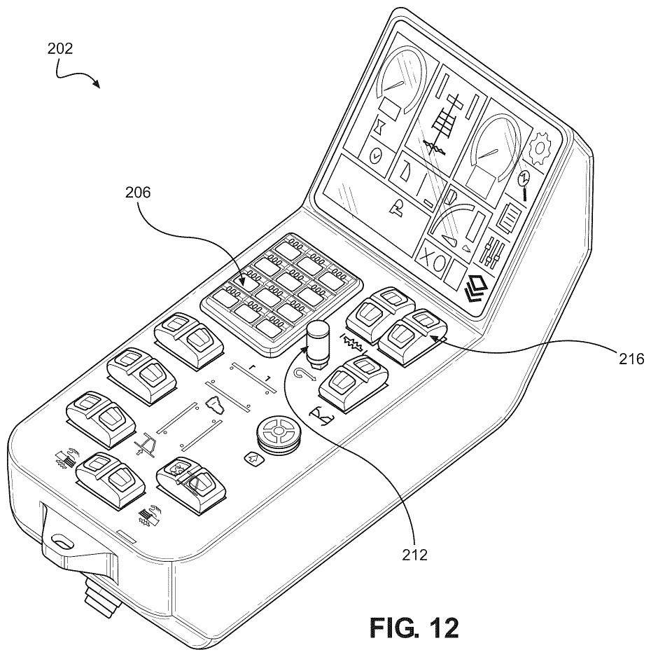

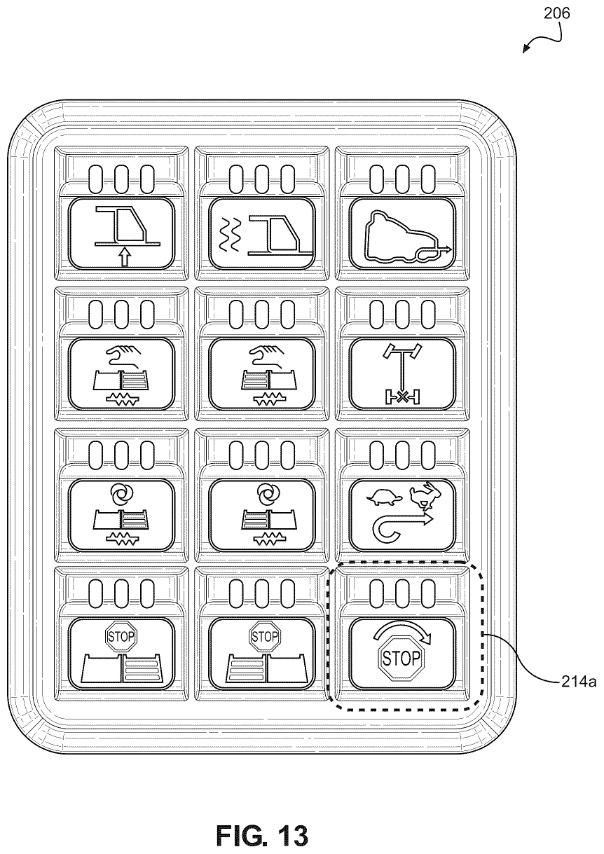

Referring to FIG. 10, the road building machine 100 includes two operator seats 110, each equipped with identical control consoles, allowing operation from either side of the machine for improved visibility during paving operations. FIG. 11 further shows a left-hand console 202 and a right-hand console 204 associated with a single operator seat 110. FIG. 12 depicts a keypad 206, the speed input mechanism 212 configured as turn-dial, and the screed float switch 216 located on the left-hand console 202. FIG. 13 further illustrates the launch control input 214a implemented as a stop/start button with LEDS 238 on the keypad 206.

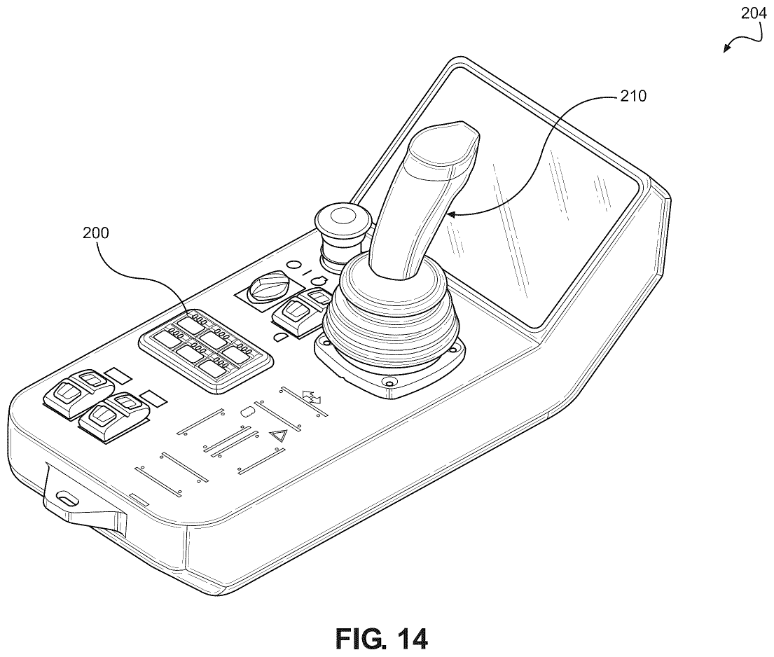

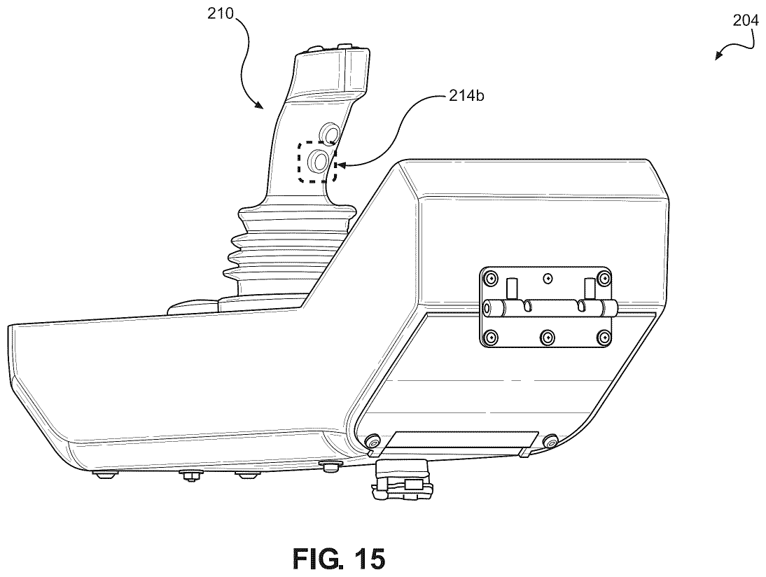

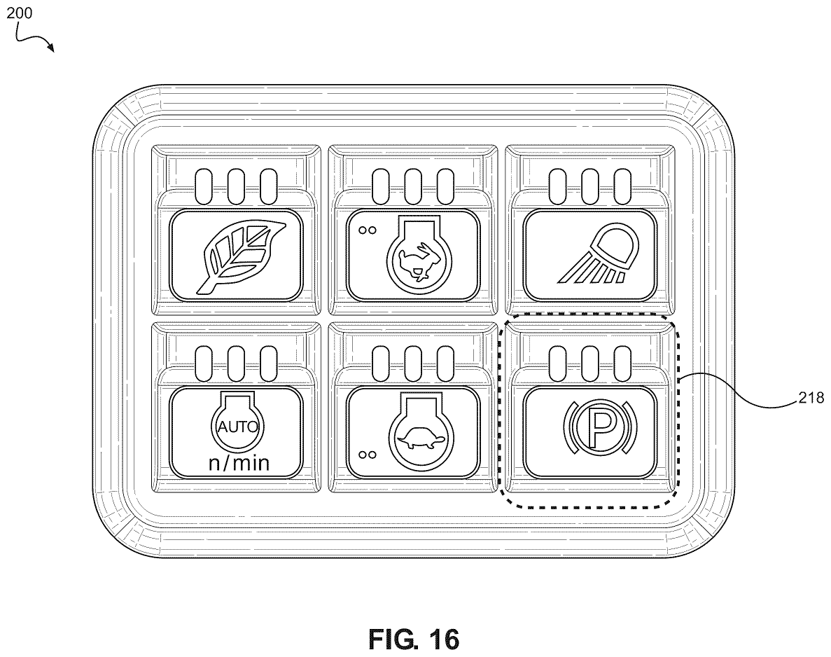

FIG. 14 illustrates the right-hand console 204, which includes the direction control device 210 configured as a joystick, and a keypad 200. FIG. 15, depicts the underside of the right-hand console 204 and direction control device 210, showing a launch control input 214b implemented as a button on the underside of the directional control device. Finally, FIG. 16 illustrates the parking brake switch 218 configured as a button with LEDS 238 on the keypad 200.

What is claimed is:

1. A method for controlling a road building machine comprising:
receiving, at a controller, an operator-selected target speed via a speed input mechanism;
receiving, at the controller, a launch initiation command via a launch control input;
automatically generating, by the controller, a controlled acceleration profile using closed-loop feedback control, wherein the controlled acceleration profile:
utilizes real-time sensor data from one or more sensors, the sensor data comprising at least one of machine speed, machine position, machine velocity, machine acceleration, and electrical current supplied to one or more propulsion components of the machine,
continuously and automatically calculates, by the controller, control outputs to adjust acceleration in real-time based on the sensor data, and
automatically transitions, by the controller, the machine from a first operational state to a second operational state at the target speed without operator input during the transition; and
automatically maintaining, by the controller, the target speed during operation using continued closed-loop feedback control;
wherein the first operational state comprises one of: a stationary state or a first movement state at a first speed; and
wherein the second operational state comprises one of: a stationary state or a second movement state at a second speed different from the first speed.

2. The method of claim 1, wherein the first operational state is a stationary state and the second operational state is a movement state at the target speed.

3. The method of claim 1, wherein the first operational state is a first movement state at a first speed and the second operational state is a second movement state at a second speed different from the first speed.

4. The method of claim 1, wherein the first operational state is a first movement state at a first speed and the second operational state is a stationary state.

5. The method of claim 1, further comprising receiving, at the controller, a directional command via a direction control device configured to transition between a neutral state and a forward state; and wherein the launch initiation command is received when the direction control device is in the forward state.

6. The method of claim 5, wherein the direction control device functions as a master control that immediately arrests all motion when transitioned to the neutral state during machine motion, regardless of other control inputs.

7. The method of claim 1, wherein the controlled acceleration profile adjusts control outputs in real-time based on variations in at least one of: ground conditions, machine load, ambient temperature, and electrical current draw from propulsion components.

8. The method of claim 1, wherein the closed-loop feedback control continuously monitors electrical currents supplied to propulsion components and adjusts the control outputs to maintain consistent acceleration.

9. The method of claim 1, further comprising implementing, by the controller, a controlled negative acceleration profile when the launch control input receives a stop command, wherein the controlled negative acceleration profile gradually reduces speed of the machine.

10. The method of claim 1, wherein the real-time sensor data comprises position data from one or more position pulse units that detect rotational position and speed of propulsion components.

11. The method of claim 1, wherein the automatically generating step produces a substantially identical acceleration profile across multiple transitions under varying environmental conditions, thereby creating consistent paving joints in a paving operation.

12. A road building machine system for providing controlled acceleration, comprising:
a speed input mechanism configured to receive an operator-selected target speed;
a launch control input configured to receive a launch initiation command;
one or more sensors configured to collect real-time data comprising at least one of: machine speed, position, velocity, acceleration, and electrical current supplied to propulsion components;
a controller configured to: receive the target speed from the speed input mechanism, receive the launch initiation command from the launch control input, receive the real-time data from the one or more sensors, automatically generate a controlled acceleration profile using closed-loop feedback control that continuously calculates and adjusts control outputs based on the real-time data, automatically transition the machine from a first operational state to a second operational state at the target speed using the controlled acceleration profile without operator input during the transition, and maintain the target speed during operation using continued closed-loop feedback control;
wherein the first operational state comprises one of: a stationary state or a first movement state at a first speed; and
wherein the second operational state comprises one of: a stationary state or a second movement state at a second speed different from the first speed.

13. The system of claim 12, further comprising:
a direction control device configured to: receive operator input to transition between a neutral state and a forward state, provide an immediate stop when transitioned to the neutral state during machine motion, and function as a master control that prevents any other control input from initiating machine movement when in the neutral state;
wherein the launch control input is subordinate to the direction control device such that the launch control input does not initiate or maintain machine movement when the direction control device is in the neutral state.

14. The system of claim 13, wherein the controller is further configured to:
detect a transition of the direction control device from the forward state back to the neutral state while the machine is in motion; and
in response to detecting said transition, immediately terminate the controlled acceleration profile and arrest machine motion without implementing a gradual negative acceleration profile, thereby providing emergency stop functionality that overrides all other control inputs.

15. The system of claim 12, wherein the controller is further configured to implement a controlled negative acceleration profile when the launch control input receives a stop command.

16. The system of claim 12, wherein the controller is configured to adjust the control outputs in real-time based on variations in electrical current draw from the propulsion components to maintain consistent acceleration.

17. The system of claim 12, wherein the one or more sensors comprise position pulse units configured to detect rotational position and speed of propulsion components.

18. The system of claim 12, wherein the controlled acceleration profile adjusts control outputs in real-time based on variations in at least one of: ground conditions, machine load, ambient temperature, and propulsion component electrical current draw.

19. A non-transitory computer-readable medium storing instructions that, when executed by a controller of a road building machine, cause the controller to perform operations comprising:
receiving an operator-selected target speed from a speed input mechanism;
receiving a launch initiation command from a launch control input;
automatically generating a controlled acceleration profile using closed-loop feedback control, wherein the controlled acceleration profile:
utilizes real-time sensor data comprising at least one of machine speed, position, velocity, acceleration, and electrical current supplied to propulsion components,
continuously and automatically calculates control outputs to adjust acceleration in real-time based on the sensor data, and
automatically transitions the machine from a first operational state to a second operational state at the target speed without operator input during the transition; and
automatically maintaining the target speed during operation using continued closed-loop feedback control,
wherein the first operational state comprises one of: a stationary state or a first movement state at a first speed, and
wherein the second operational state comprises one of: a stationary state or a second movement state at a second speed different from the first speed.

20. The non-transitory computer-readable medium of claim 19, wherein the instructions further cause the controller to adjust the control outputs in real-time based on variations in at least one of: ground conditions, machine load, ambient temperature, and electrical current draw from propulsion components.
